(19) United States
(12) Patent Application Publication
(10) Pub. No.: US 2011/0060510 A1
(43) Pub. Date: Mar. 10, 2011

(54) Systems and Methods for Increasing Brake Pressure

(75) Inventors: Philip A. Barber, Olton (GB); Simon P. Gilling, Kenilworth (GB)

(73) Assignee: JAGUAR CARS, LIMITED, Coventry (GB)

(21) Appl. No.: 12/556,730

(22) Filed: Sep. 10, 2009

(51) Int. Cl. G06F 19/00; B60T 11/10

(52) U.S. Cl. 701/70; 188/347

(57) ABSTRACT

A vehicle brake system includes a brake unit, a brake line associated with the brake unit, and an activatable pyrotechnic device associated with the brake line. Upon activation, the pyrotechnic device is configured to supply gas directly into the brake line to increase pressure in the brake line, such that increased pressure is applied to the brake unit.

### BACKGROUND OF THE INVENTION

1. Field of the Invention

The present disclosure relates to systems and methods for increasing brake pressure using one or more pyrotechnic devices.

2. Background Art

A vehicle may be provided with an emergency brake intervention system that automatically builds up brake pressure in the event that a potential collision situation is detected. Such a system may detect a rapid closing of the vehicle on an obstacle using a radar system or other vision or laser rangefinder device. In the event that a collision situation is detected, brake pressure may be built up automatically by a vacuum brake booster or a pump of an antilock braking system.

### SUMMARY

According to an embodiment of the present disclosure, a vehicle brake system may be provided with a brake unit, a brake line associated with the brake unit, and an activatable pyrotechnic device associated with the brake line. Upon activation, the pyrotechnic device is configured to supply gas directly into the brake line to increase pressure in the brake line, such that increased pressure is applied to the brake unit.

A method of increasing braking pressure in a vehicle brake system that includes a brake unit and a brake line associated with the brake unit is also provided. The method includes detecting a potential collision event, and activating a pyrotechnic device in response to detection of the potential collision event, such that gas is supplied directly into the brake line to increase pressure applied to the brake unit.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic view of a vehicle including a brake system in accordance with the present disclosure;

FIG. 2 is an enlarged view of a pyrotechnic device of the brake system of FIG. 1;

FIG. 3 is a schematic view of a vehicle including another embodiment of a brake system in accordance with the present disclosure; and

FIG. 4 is a schematic view of a vehicle including yet another embodiment of a brake system in accordance with the present disclosure.

### DETAILED DESCRIPTION

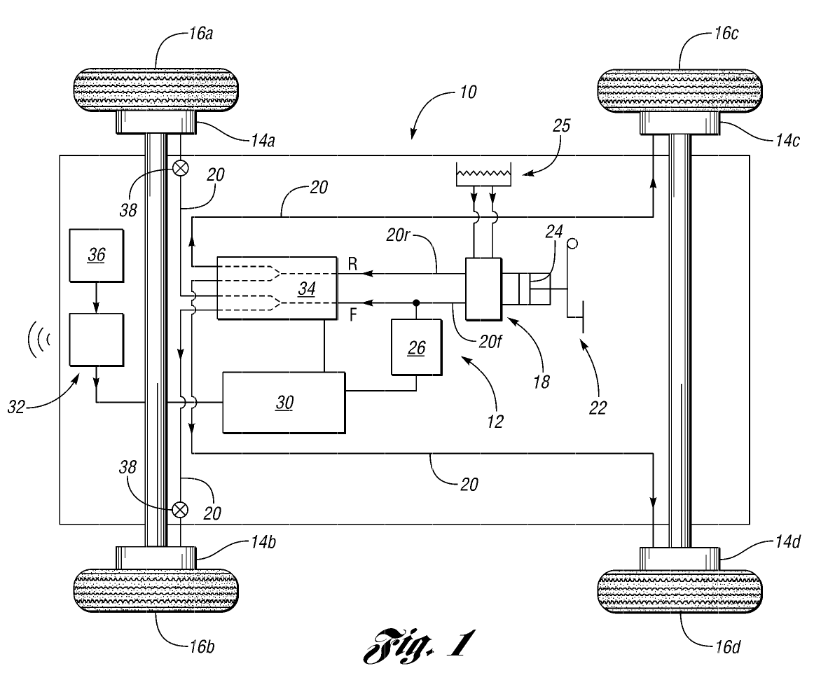

FIG. 1 shows a motor vehicle 10 having a brake system 12 according to the present disclosure. The brake system 12 is configured to improve brake response of the vehicle 10, as explained below in detail.

The brake system 12 may include one or more brake units 14 that are each associated with a particular wheel 16, or other motion device, of the vehicle 100. In the embodiment shown in FIG. 1, the brake system has four brake units 14, including two front brake units 14a,b associated with front wheels 16a,b, and two rear brake units 14c,d associated with rear wheels 16c,d. Furthermore, each brake unit 14 may be any suitable brake device such as a disk brake device or a drum brake device. For example, each front brake unit 14a,b may include a disk brake device, and each rear brake unit 14c,d may include a drum brake device.

The brake units 14 are connected to one or more brake pumps, such as a master cylinder 18, by one or more brake lines 20, such as tubes and/or hoses, that contain a suitable brake fluid, such as hydraulic oil. The master cylinder 18 is configured to increase pressure in the brake lines 20 in response to a vehicle operator depressing a brake pedal 22, which is operatively connected to or otherwise associated with the master cylinder 18. For example, the brake pedal 22 may be connected directly or indirectly to a plunger or piston 24 of the master cylinder 18, such that downward and/or forward movement of the brake pedal 22 may cause movement of the piston 24 from an initial position to a brake-actuate position. As a result, the master cylinder 18 forces brake fluid through the brake lines 20, thereby applying increased pressure at the brake units 14, which causes the brake units 14 to apply braking force on the wheels 16.

In the embodiment shown in FIG. 1, the master cylinder 18 is connected to two brake lines 20f,r. The brake line 20f is connected to additional brake lines 20 that supply brake fluid to the front brake units 14a,b, and the brake line 20r is connected to additional brake lines 20 that supply brake fluid to the rear brake units 14c,d.

The master cylinder 18 may also be in fluid communication with a reservoir 25 that contains additional brake fluid. The master cylinder 18 may draw brake fluid from the reservoir 25 as needed to sufficiently increase pressure in the brake lines 20.

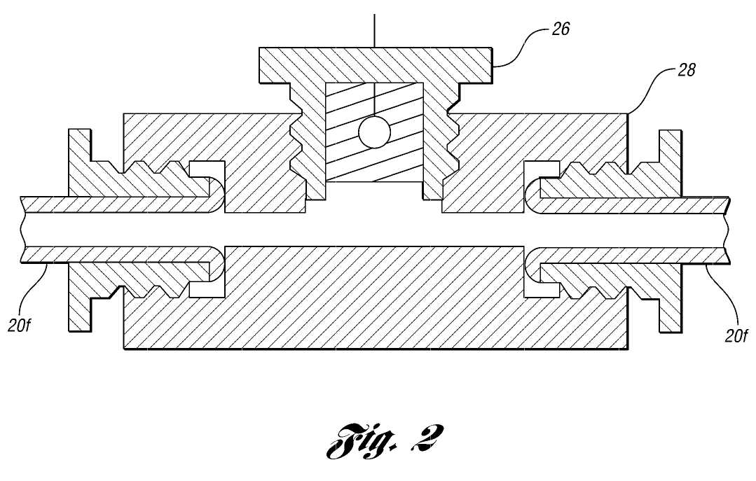

The brake system 12 further includes one or more pyrotechnic devices, such as pyrotechnic charges or cartridges, associated with one or more of the brake lines 20 for rapidly increasing pressure in the one or more brake lines 20. Each pyrotechnic device may be any suitable device, such as a gas generator used in air bag system or seat belt pretensioner for example. In the embodiment shown in FIG. 1, the brake system 12 includes a single pyrotechnic device 26 that is connected to the brake line 20f downstream of the master cylinder 18. For example, referring to FIG. 2, the pyrotechnic device 26 may be threadingly connected to a mount 28 that is also threadingly connected to portions of the brake line 20f.

The pyrotechnic device 26 is configured to increase pressure in the brake line 20f as explained below in detail. Furthermore, the pyrotechnic device 26 may increase pressure in the brake line 20f to any suitable level, such as a pressure in the range of about 100 to 120 bar.

In another embodiment, an additional pyrotechnic device 26 may be connected to the brake line 20r. In yet another embodiment, a brake system according to the present disclosure may include a single pyrotechnic device 26 connected to the brake line 20r, and no pyrotechnic device connected to the brake line 20f.

The brake system 12 shown in FIG. 1 further includes an electronic brake controller 30 for controlling operation of the pyrotechnic device 26, a collision detection system (CDS) 32 in communication with the controller 30, and an anti-lock braking system (ABS) modulator 34 that is also in communication with the controller 30. The controller 30 may include one or more control units or modules that each include, for example, a central processing unit (CPU) including a microprocessor, and a memory management unit (MMU) in communication with the CPU. The MMU may control movement of data among various computer readable storage media and communicate data to and from the CPU. In one embodiment, the computer readable storage media include stored data or code representing instructions executable by controller 30 to control operation of the pyrotechnic device 26 and/or ABS modulator 34 based on input from the CDS 32.

The CDS 32 may be positioned at or near a front portion of the vehicle 10, and may have any suitable components for sensing or otherwise detecting a potential collision event. For example, the CDS 32 may include a radar system and/or a laser system for detecting an obstacle or target in the path of the vehicle 10 or approaching the vehicle 10. Alternatively or supplementally, the CDS 32 may include one or more sensors that sense a vehicle parameter that may be indicative of a potential collision event. For example, the CDS 32 may include an accelerometer 36 that is configured to detect sudden changes in vehicle acceleration.

The ABS modulator 34 is configured to control or regulate pressure in the brake lines 20 to inhibit or prevent lock up of any of the wheels 16 during braking events. In the embodiment shown in FIG. 1, the ABS modulator 34 is positioned downstream of the pyrotechnic device 26. With this configuration, the ABS modulator 34 may be used to control or regulate pressure in the brake line 20f, which is connected to the pyrotechnic device 26, to inhibit or prevent lock up of the front wheels 16a,b when the pyrotechnic device 26 is activated. In another embodiment, the ABS modulator 34 may be positioned upstream of the pyrotechnic device 26 or omitted from the brake system 12.

Referring to FIGS. 1 and 2, operation of the brake system 12 will now be described. When the CDS 32 detects a potential collision event, such as by sensing the presence of an object and/or sensing a rapid change in acceleration of the vehicle 10, that information is communicated to the controller 30. The controller 30 may then activate the pyrotechnic device 26, such as with an electrical signal, optical signal or mechanical impetus. When activated, such as by detonation or deflagration, the pyrotechnic device 26 introduces hot gas, such as nitrogen or any other suitable gas or gasses, directly into the brake line 20f. As a result, increased pressure is rapidly applied to the brake units 14a,b associated with the front wheels 16a,b, thereby causing the brake units 14a,b to automatically apply brake pressure to the front wheels 16a,b or to automatically increase brake pressure on the front wheels 16a,b, such that brake action of the vehicle operator may be reinforced. The brake line 20f may also include a flow regulator, such as a constricted region or a poppet valve, to inhibit or prevent flow of brake fluid toward the reservoir 25 when the pyrotechnic device 26 is activated.

With the above configuration, the pyrotechnic device 26 supplies gas directly into the brake line 20f such that the gas contacts the brake fluid. The gas may subsequently be bled out from the brake line or lines 20 through one or more bleed ports 38, such that the brake system 12 may be returned to normal operation.

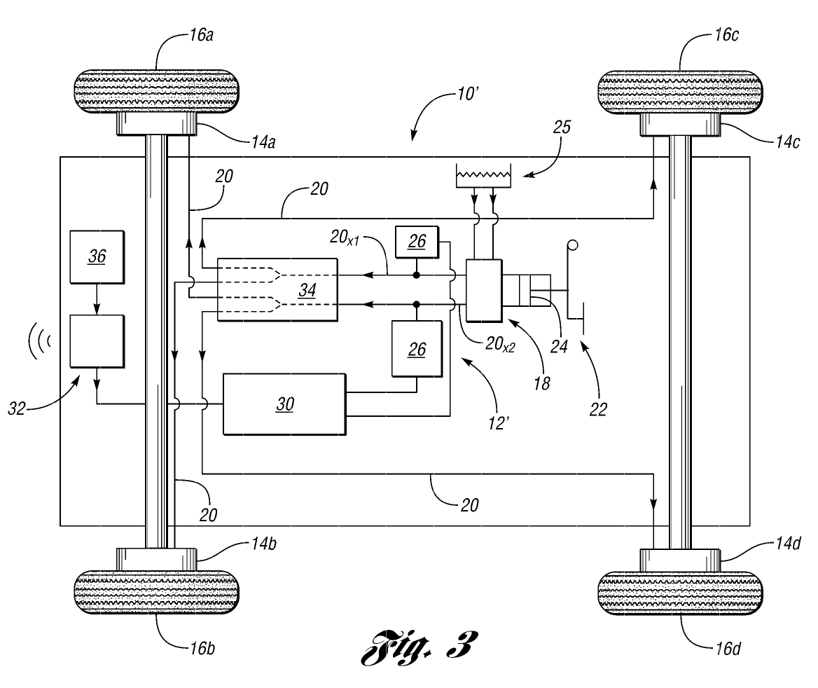

FIG. 3 shows another embodiment 12′ of a brake system according to the present disclosure. The brake system 12′ includes similar components as the brake system 12, and those similar components are identified with the same reference numbers. Rather than including a single pyrotechnic device 26, however, the brake system 12′ includes two pyrotechnic devices 26. One pyrotechnic device 26x₁ is connected to a first brake line 20x₁, and the other pyrotechnic device 26 is connected to a second brake line 20x₂. As shown in FIG. 3, the first brake line 20x₁ is connected by additional brake lines 20 to the left front brake unit 14b and right rear brake unit 14c, and the second brake line 20x₂ is connected by additional brake lines 20 to the right front brake unit 14a and left rear brake unit 14d.

With such a configuration, in response to detection of a potential collision event by the CDS 32, the controller 30 may be used to control operation of the pyrotechnic devices 26 to automatically apply braking force on all wheels 16 or reinforce braking action of the vehicle operator. As another example, the controller 30 may activate only one of the pyrotechnic devices 26 in response to detection of a potential collision event.

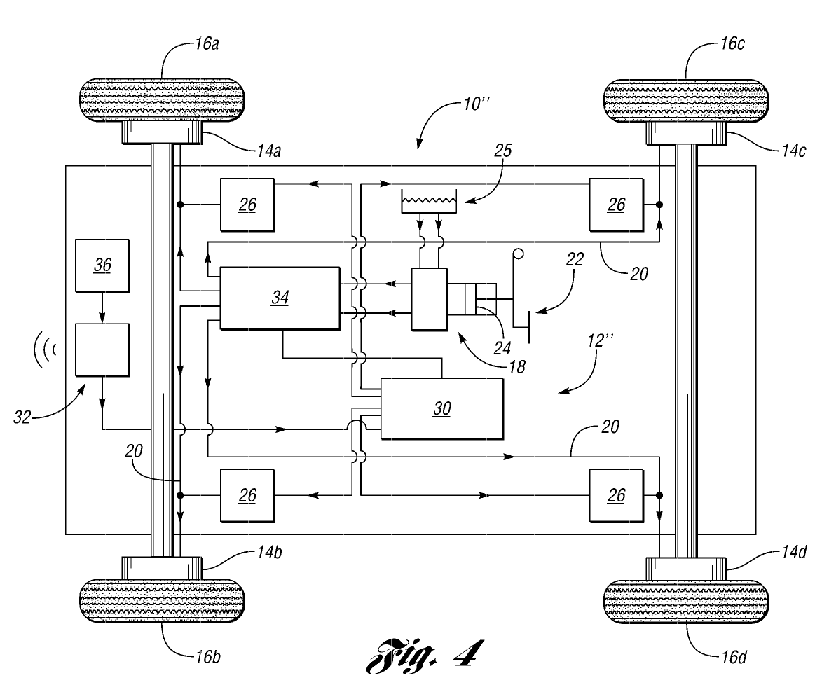

FIG. 4 shows yet another embodiment 12″ of a brake system in accordance with the present disclosure. The brake system 12″ includes similar components as the brake system 12, and those similar components are identified with the same reference numbers. Rather than including a single pyrotechnic device 26, however, the brake system 12″ includes four pyrotechnic devices 26. Each pyrotechnic device 26 is associated with a particular brake unit 14. For example, each pyrotechnic device 26 may be connected to a brake line 20 that is connected directly to a particular brake unit 14.

With such a configuration, in response to detection of a potential collision event by the CDS 32, the controller 30 may activate all of the pyrotechnic devices 26 to automatically apply braking force on all wheels 16, or reinforce braking action of the vehicle operator. As another example, the controller 30 may selectively activate one or more of the pyrotechnic devices 26 in response to detection of a potential collision event. For instance, one or both pyrotechnic devices 26 on one side of the vehicle 10″ may be activated to introduce a yaw moment on the vehicle 10″ to cause the vehicle 10″ to turn toward or away from an obstacle. As a result, the direction of the vehicle 10″ may be adjusted or altered to optimize protection afforded by other safety features, such as safety devices or crumple zones, of the vehicle 10″. For example, if the vehicle 10″ is provided with a front crumple zone to dissipate energy, the pyrotechnic devices 26 may be selectively activated to cause the vehicle 10″ to turn toward an obstacle such that the front crumple zone contacts the obstacle. More generally, the pyrotechnic devices 26 may be selectively activated to cause the vehicle 10″ to turn such that collision energy transferred to a vehicle occupant may be minimized.

It should be noted that the brake lines 20 in the embodiment shown in FIG. 4 may be arranged in any suitable configuration. For example, the brake lines 20 may be arranged in a front-rear split configuration in which one brake line from the master cylinder 18 supplies or feeds brake fluid to both front brake units 14a,b, and another brake line from the master cylinder 18 feeds brake fluid to both rear brake units 14c,d. As another example, the brake lines 20 may be arranged in an x-split configuration in which one brake line from the master cylinder 18 feeds brake fluid to the left front brake unit 14b and right rear brake unit 14c, and another brake line from the master cylinder 18 feeds brake fluid to the right front brake unit 14a and left rear brake unit 14d.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle brake system comprising:
a brake unit;
a brake line associated with the brake unit; and
an activatable pyrotechnic device associated with the brake line and configured to supply gas directly into the brake line to increase pressure in the brake line upon activation, such that increased pressure is applied to the brake unit.

2. The brake system of claim 1 further comprising a brake pump connected to the brake line, wherein the pyrotechnic device is located downstream of the brake pump.

3. The brake system of claim 1 further comprising brake fluid disposed in the brake line, wherein the pyrotechnic device is configured to supply the gas directly into the brake line such that the gas contacts the brake fluid upon activation of the pyrotechnic device.

4. The brake system of claim 1 wherein the brake unit comprises a disk brake device.

5. The brake system of claim 1 wherein the brake unit comprises a drum brake device.

6. The brake system of claim 1 further comprising an anti-lock brake system modulator connected to the brake line, and wherein the pyrotechnic device is located upstream of the anti-lock brake system modulator.

7. The brake system of claim 1 further comprising an additional brake unit associated with the brake line, and wherein, upon activation, the pyrotechnic device is configured to increase pressure applied to the additional brake unit.

8. The brake system of claim 7 further comprising an anti-lock brake system modulator disposed downstream of the pyrotechnic device for regulating pressure in the brake line.

9. The brake system of claim 1 further comprising an additional brake unit, an addition brake line associated with the additional brake unit, and an additional activatable pyrotechnic device associated with the additional brake line, wherein, upon activation, the additional pyrotechnic device is configured to supply additional gas directly into the additional brake line to increase pressure in the additional brake line, such that increased pressure is applied to the additional brake unit.

10. A vehicle comprising:
multiple brake units;
multiple brake lines associated with the brake units;
multiple pyrotechnic devices that are each associated with a respective brake line and a respective brake unit, each pyrotechnic device being configured to introduce gas into the respective brake line upon activation to thereby increase pressure applied to the respective brake unit; and
a controller that is configured to selectively activate the pyrotechnic devices.

11. The vehicle of claim 10 further comprising an anti-lock brake system modulator disposed upstream of the pyrotechnic devices.

12. A method of increasing braking pressure in a brake system of a vehicle, wherein the brake system includes a brake unit and a brake line associated with the brake unit, the method comprising:
detecting a potential collision event; and
activating a pyrotechnic device in response to detection of the potential collision event, such that gas is supplied directly into the brake line to increase pressure applied to the brake unit.

13. The method of claim 12 wherein the brake system includes multiple brake units, and activating the pyrotechnic device is performed such that increased pressure is applied to each brake unit.

14. The method of claim 12 wherein the brake system includes an additional brake unit, an addition brake line associated with the additional brake unit, and an additional activatable pyrotechnic device associated with the additional brake line, and wherein the method further comprises activating the additional pyrotechnic device in response to detection of the potential collision event, such that gas is supplied directly into the additional brake line to increase pressure applied to the additional brake unit.

15. The method of claim 12 wherein activating the pyrotechnic device is performed such that a travel direction of the vehicle is altered.

16. The method of claim 15 wherein activating the pyrotechnic device is performed to cause the vehicle to turn such that collision energy transferred to a vehicle occupant is minimized.
